(19) United States
(12) Patent Application Publication
(10) Pub. No.: US 2001/0056310 A1
(43) Pub. Date: Dec. 27, 2001

(54) Task instructing method and apparatus, storage medium for storing the method, card type storage medium used by the apparatus, and task instructing and managing system

(75) Inventor: Miyoshi Aoki, Tokyo (JP)

Correspondence Address: MCDERMOTT WILL & EMERY, 600 13TH STREET, N.W., WASHINGTON, DC, 20005-3096, US

(73) Assignee: Mitsubishi Denki Kabushiki Kaisha

(21) Appl. No.: 09/755,176

(22) Filed: Jan. 8, 2001

(30) Foreign Application Priority Data
Jun. 23, 2000 (JP) 2000-190127

(51) Int. Cl. G06F 19/00

(52) U.S. Cl. 700/116; 700/115; 235/487

(57) ABSTRACT

A task instructing method for use with a work slip issuing terminal 12 and work terminals 14 is provided. The work slip issuing terminal 12 includes a reader/writer 121 which is connected to a central managing apparatus 10 storing task detail update information and which writes and reads information to and from a rewritable print indication area of a card type storage medium. Each of the work terminals 14 also includes a reader/writer connected to the central managing apparatus 10. The method comprises the steps of: causing the work slip issuing terminal 12 to print task details retrieved from the central managing apparatus 10 onto the card type storage medium that is issued as a work slip 20; and causing the work terminal 14, given the work slip 20, to search the central managing apparatus 10 for task detail update information so that the retrieved information is printed on the work slip 20.

### BACKGROUND OF THE INVENTION

1. Field of the Invention

The present invention relates to a method and an apparatus for instructing workers manning work facilities on details of task to be done, a storage medium for recording the instructing method, a card type storage medium for use with the apparatus, and a task instructing and managing system, wherein the card type storage medium has a rewritable print indication area and is attached to a workpiece that moves from one work facility to another according to a predetermined work schedule, and wherein the card type storage medium has details of task printed thereon at each work facility upon access to update information held in a central processing unit so that workers manning the facility will know what to do.

2. Description of the Related Art

Fabrication of semiconductor products involves such processes as oxidation, photolithography, diffusion, epitaxial growth, and ion implantation carried out successively or repeatedly. To perform these processes requires moving materials or partially finished products from one piece of equipment or work facility to another. The processes can number as many as hundreds and take as long as dozens of days to complete.

When partially finished products move through these complex processes over extended periods of time, each product is furnished with a document called a task instruction sheet carrying information for identifying the product as well as task instructions detailing task to be done. Generally, workers manning each of the work facilities perform their task by following the task instructions indicated by the task instruction sheet attached to the forwarded product.

As outlined above, semiconductor products must run through hundreds of processes over dozens of days before they are finished. Meanwhile, advances and improvements in semiconductor technology are phenomenal and occurring at very short intervals. The state of the art, along with design changes requested by customers, necessitates continuously modifying process flows and details of task.

Conventionally, the task instruction sheet must be printed anew on paper whenever it is updated to reflect any changes in process flows or task details. Getting the instruction sheet printed is a time-consuming chore, which has made it difficult for workers to keep up with perpetual modifications.

Japanese Published Unexamined Patent Application No. Hei 1-257549 discloses a method for furnishing each product moving from one process to another with an IC card that contains information denoting task instructions. One disadvantage of this method is that the IC card, to be read on a CRT of a terminal, must be carried by workers repeatedly to the terminal for viewing its contents.

Japanese Published Unexamined Patent Application No. Sho 63-7256 describes a method for providing each product forwarded from one process to another with an IC card which has a liquid crystal display and which contains information about details of fabrication. In operation, the information stored in the IC card is displayed on its LCD for workers to verify. According to this method, task instruction data displayed on the LCD merely amounts to a process sequence indicating ID numbers of production process managing apparatus or of production facilities designated by such apparatus. Task details (recipes) corresponding to the task instruction sheet are not displayed.

If the recipes were to be displayed, that would require a large-sized liquid crystal display rendering the IC card inordinately expensive. In addition, the LCD, a precision instrument, must be handled with care at the work site, which can be an impediment to work efficiency.

Japanese Patent No. 2508870 discloses a method for averting misinterpretations by workers of task instructions. Specifically, the method involves making each task instruction sheet carry a bar code designating specific task details. The bar code on the sheet is read by a bar code reader at each work facility to display task details regarding the facility in question. The display ensures reliable verification of the task details by workers manning each work facility, thus aiming to eliminate possible mismatch between products and task to be done.

### SUMMARY OF THE INVENTION

The present invention has been made in view of the above circumstances and provides a task instructing method and apparatus, a storage medium for recording the instructing method, a card type storage medium for use with the apparatus, and a task instructing and managing system, all inexpensive and easy to handle, allowing works continuously to verify extensive task details and to modify or switch task instruction sheets promptly to reflect update information composed of changes in process flows or task details.

It is an object of the invention to provide a task instructing method for facilitating delivery of task instructions that reflect changes in process flows and task details.

It is another object of the invention to provide a task instructing apparatus for reading necessary information from the card type storage medium having the rewritable print indication area, and searching the central managing apparatus for the most recent task detail information about the workpiece to which the medium has been attached.

A further object of the invention provides a card type storage medium for inexpensively printing of update and a large quantity of task detail information about the workpiece at each work facility.

It is yet another object of the invention to provide a task instructing and managing system for reading necessary information from the card type storage medium transferred along with the workpiece, based on the information thus read, searching the central managing apparatus for the most recent task detail information about the workpiece, and printing the most recent task detail information on the card type storage medium.

It is yet another object of the invention to provide a storage medium for readily permitting widespread distribution of technical steps constituting the task instructing method that facilitates delivery of task instructions reflecting changes in process flows and task details.

A task instructing method according to the invention is used with a first and a second terminal device. The first terminal device comprises an interface for exchanging information with a central managing apparatus, which includes a storage unit storing update information about specific work facilities for processing a workpiece and about details of task to be carried out on the workpiece at each of the work facilities, a reader/writer for writing and reading information to and from a card type storage medium, which provides a print indication area to print information in a rewritable manner through the reader/writer, an input unit for entering information to the reader/writer, and a display unit for displaying information entered through the input unit. The second terminal device comprises an interface for exchanging information with the central managing apparatus, and a reader/writer for writing and reading information to and from the card type storage medium. The task instructing method includes the steps of causing the first terminal device to print, on a card type storage medium that provides a print indication area to print information in a rewritable manner through the reader/writer, specific information identifying each workpiece and designating details of task to be carried out on the workpiece at the next work facility to be transferred in accordance with the update information retrieved from the storage unit, thus issuing the card type storage medium which is transferred together with the workpiece and causing the second terminal device, by using the card type storage medium transferred together with the workpiece to the work facility in question, to access and search the central managing apparatus for update information about details of task to be carried out on the workpiece at the work facility in question, and to print details of task on the card type storage medium in accordance with the update information retrieved from the storage unit.

A task instructing apparatus according to the invention comprises a central managing apparatus having a storage unit storing update information about specific work facilities for processing a workpiece and about details of task to be carried out on the workpiece at each of the work facilities; a first terminal device having an interface for exchanging information with the central managing apparatus, a reader/writer for writing and reading information to and from a card type storage medium, which provides a print indication area to print information in a rewritable manner through the reader/writer, an input unit for entering information to the reader/writer, and a display unit for displaying information entered through the input unit; and a second terminal device having an interface for exchanging information with the central managing apparatus, and a reader/writer for writing and reading information to and from the card type storage medium, the second terminal device being attached to each work facility.

A card type storage medium according to the invention is transferred together with a workpiece and provides a print indication area to print information thereon in a rewritable manner, the information being such as identifying each workpiece and designating details of task to be carried out on the workpiece at the next work facility.

A task instructing and managing system according to the invention comprises a card type storage medium which is transferred together with a workpiece and which provides a print indication area to print information thereon in a rewritable manner, the information being such as dentifying each workpiece and designating details of task to be carried out on the workpiece at the next work facility; a central managing apparatus having a storage unit storing update information about specific work facilities for processing a workpiece and about details of task to be carried out on the workpiece at each of the work facilities; a first terminal device having an interface for exchanging information with the central managing apparatus, a reader/writer for writing and reading information to and from a card type storage medium, which provides a print indication area to print information in a rewritable manner through the reader/writer, an input unit for entering information to the reader/writer, and a display unit for displaying information entered through the input unit; and a second terminal device having an interface for exchanging information with the central managing apparatus, and a reader/writer for writing and reading information to and from the card type storage medium, the second terminal device being attached to each work facility.

A storage medium according to the invention stores a task instructing method for use with a first and a second terminal device; the first terminal device comprises an interface for exchanging information with a central managing apparatus, which includes a storage unit storing update information about specific work facilities for processing a workpiece and about details of task to be carried out on the workpiece at each of the work facilities, a reader/writer for writing and reading information to and from a card type storage medium, which provides a print indication area to print information in a rewritable manner through the reader/writer, an input unit for entering information to the reader/writer, and a display unit for displaying information entered through the input unit, and the second terminal device comprises an interface for exchanging information with the central managing apparatus, and a reader/writer for writing and reading information to and from the card type storage medium; the task instructing method including the steps of causing the first terminal device to print, on a card type storage medium that provides a print indication area to print information in a rewritable manner through the reader/writer, specific information identifying each workpiece and designating details of task to be carried out on the workpiece at the next work facility to be transferred in accordance with the update information retrieved from the storage unit, thus issuing the card type storage medium which is transferred together with the workpiece; and causing the second terminal device, by using the card type storage medium transferred together with the workpiece to the work facility in question, to access and search the central managing apparatus for update information about details of task to be carried out on the workpiece at the work facility in question, and to print details of task on the card type storage medium in accordance with the update information retrieved from the storage unit.

Other objects and advantages of the invention will become apparent from the detailed description given hereinafter. It should be understood, however, that the detailed description and specific embodiments are given by way of illustration only since various changes and modifications within the scope of the invention will become apparent to those skilled in the art from this detailed description.

### BRIEF DESCRIPTION OF THE DRAWINGS

FIG. 1 is a schematic view outlining an overall structure of a task instructing method embodying the invention.

FIG. 2 is a schematic view of a work slip according to the invention.

FIG. 3 is a flowchart of steps constituting the inventive task instructing method.

In all figures, the substantially same elements are given the same reference number.

### DESCRIPTION OF THE PREFERRED EMBODIMENT

First Embodiment

A task instructing method practiced as a first embodiment of the invention involves attaching a card type storage medium to each workpiece that is forwarded from one work facility to another and worked on according to predetermined task details. The storage medium has a rewritable print indication area. At a given work facility, the card type storage medium is used to reference a central processing unit for any updates of task details applicable to the facility in question. The referenced update information is printed on the card type storage medium so that workers manning the facility will proceed with appropriate task by checking the printout.

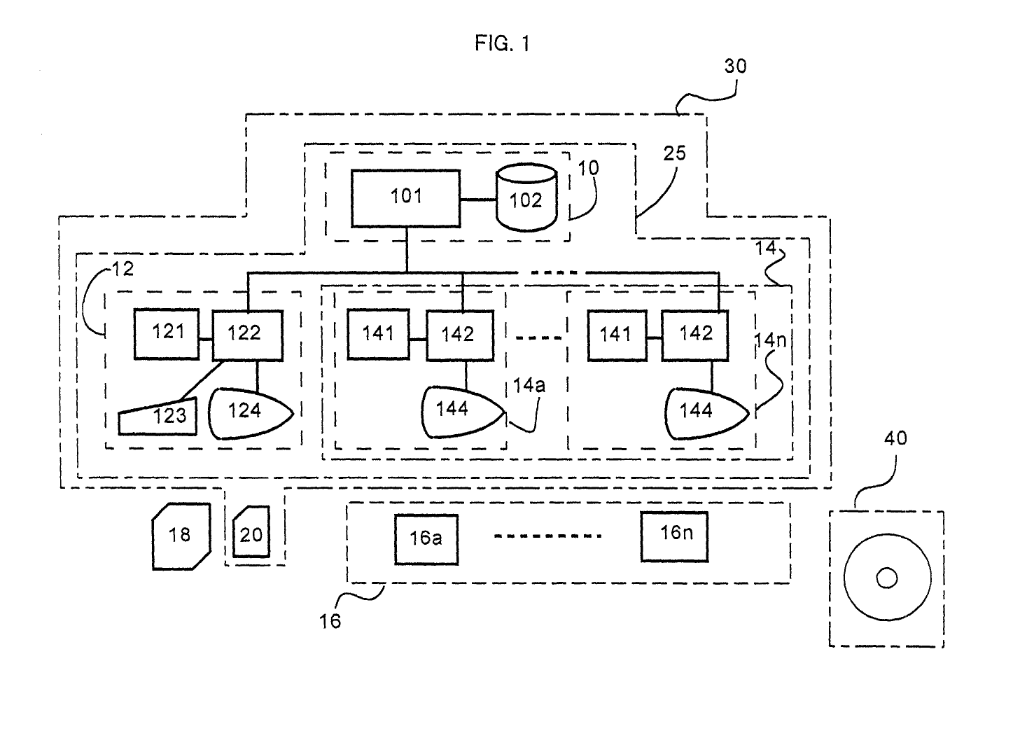

FIG. 1 schematically outlines an overall structure of a task instructing method embodying the invention.

In FIG. 1, reference numeral 10 stands for a central managing apparatus that comprises a host computer 101 and a storage device 102 acting as a storage device of a task detail.

Reference numeral 12 denotes a work slip issuing terminal as a first terminal device, a personal computer is applied to the work slip issuing terminal 12. The work slip issuing terminal 12 includes a reader/writer 121 for writing and reading information to and from a work slip 20, to be described later, an interface 122 for permitting information exchanges with the host computer 101 of the central managing apparatus 10, a keyboard 123 acting as an input unit, and a CRT display 124 serving as a display unit.

Reference numeral 14 represents work terminal devices, a group of personal computers acting as work terminals 14a, . . . , 14n corresponding respectively to work facilities 16a, . . . , 16n that constitute a work facility group 16. Each work terminal comprises a reader/writer 141 for writing and reading information to and from the work slip 20, an interface 142 for permitting information exchanges with the host computer 101 of the central managing apparatus 10, and a CRT display 144 serving as a display unit. A keyboard may be provided as an input unit if necessary.

The work slip issuing terminal 12 and work terminal devices 14 are connected through their respective interfaces 122 and 142 to the host computer 101 of the central managing apparatus 10.

Reference numeral 18 denotes a semiconductor product as a workpiece, and reference numeral 20 stands for a work slip as a task instruction sheet, a card type storage medium forwarded together with the product 18. The work slip 20 is composed of a rewritable card having a rewritable print indication area 201. Reference numeral 25 represents a task instructing apparatus comprising the central managing apparatus 10, the work slip issuing terminal 12, and work terminal devices 14. Reference numeral 30 denotes a task instructing and managing system that includes the task instructing apparatus 25 and work slip 20.

The storage device 102 of the central managing apparatus 10 retains diverse items of information about semiconductor products 18 to be forwarded through the work facilities 16. Illustratively, the most recent details of task to be done on a specific semiconductor product 18 at each work facility are stored in association with information for identifying that product 18 and with information for designating the task details applicable to the facility in question.

The keyboard 123 attached to the work slip issuing terminal 12 is used to record information such as a type name and a lot number identifying each semiconductor product 18 and to issue a rewritable card type work slip 20 carrying information designating details of task. Loaded with the rewritable work slip 20, the reader/writer 121 prints on the slip 20 information that is entered through the keyboard 123 or sent from the storage device 102 in the central managing apparatus 10 where the information has been stored.

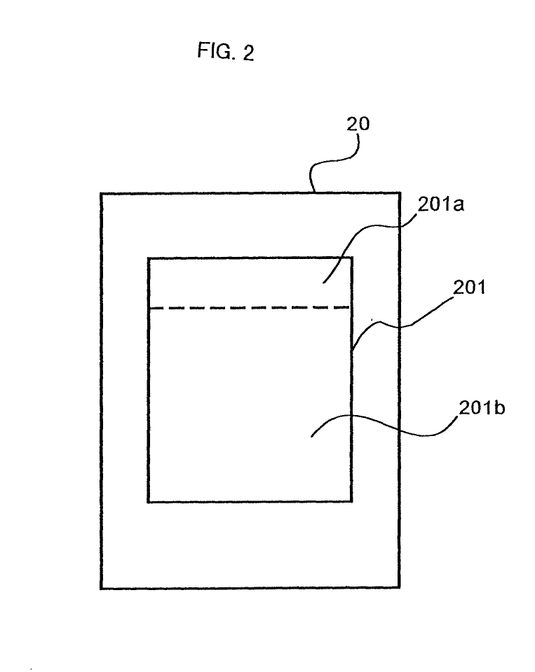

FIG. 2 is a schematic view of a work slip according to the invention.

In FIG. 2, reference numeral 20 denotes the work slip composed of a rewritable card with a print indication area 201 capable of having information printed thereon in a rewritable manner. The print indication area 201 is constituted illustratively by a color-developing heat-sensitive rewritable material. The heat-sensitive rewritable material is based on a white polyester film containing reversible heat-sensitive elements that develop such colors as blue, red and black. For its excellent visibility, the colorful print indication area 201 minimizes misinterpretations of printed information. The color-developing heat-sensitive rewritable material may be replaced by a phase change recording film made of a Ge—Te—Sb alloy.

The print indication area 201 is made up of two parts: a fixed print part 201a and a variable print part 201b. The fixed print part 201a has information printed fixedly thereon upon issuance of the slip by the work slip issuing terminal 12. The printed contents in the part 201a cannot be varied by any work terminal 14. A type name and a lot number identifying the semiconductor product 18 are printed on the fixed print part 201a.

The variable print part 201b may have information printed thereon in a variable manner not only by the work slip issuing terminal 12 but also by a work terminal 14. Details of task to be carried out such as specific recipes and remarks applicable to the product 18 are printed on the variable print part 201b. The print indication area, making up a storage medium having information printed for indication purposes, displays a greater quantity of printed task instructions at lower cost than conventional LCD-based indicator arrangements.

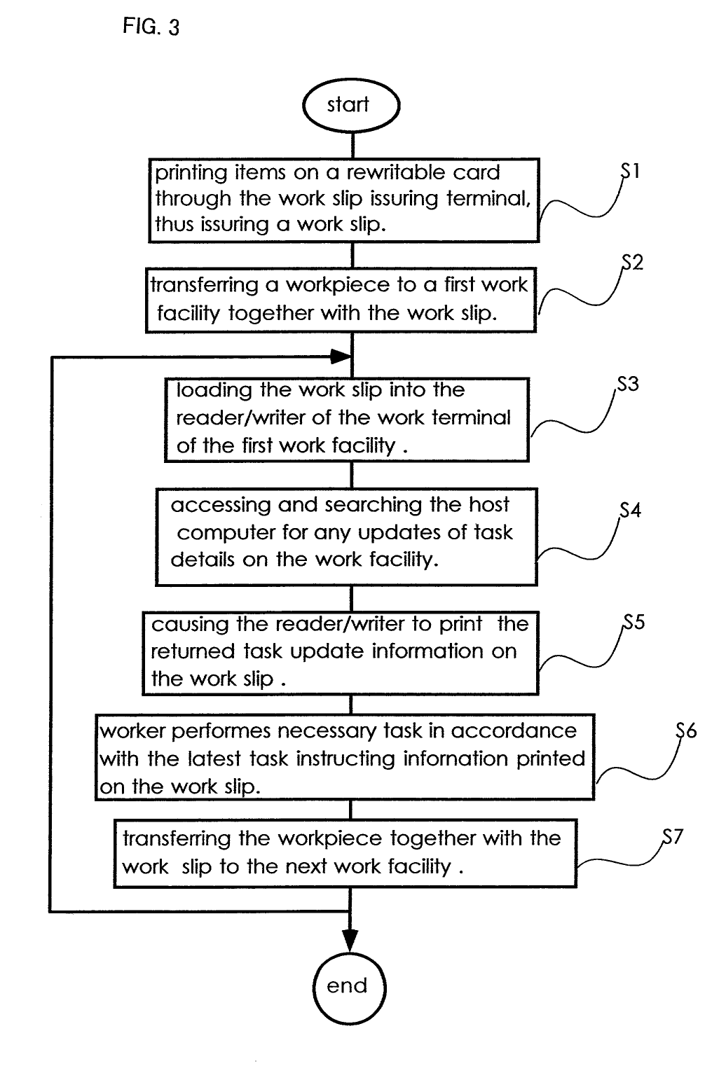

FIG. 3 is a flowchart of steps constituting the inventive task instructing method.

As shown in FIG. 3, the work slip 20 issued by the work slip issuing terminal 12 is loaded into the reader/writer 121. Task instructing information entered through the keyboard 123 to identify the semiconductor product 18 such as its type and its lot number is printed on the fixed print part 201a in the print indication area 201 of the work slip 20. The information printed on the fixed print part 201a is transmitted simultaneously to the central managing apparatus 10. In response, the most recent task details applicable to the product 18 in question are retrieved from the storage device 102, sent back and printed on the variable print part 201b in the print indication area 201. The work slip 20 is issued in this manner (step S1).

The issued work slip 20 is attached to the semiconductor product 18 so that they are transferred together to a first work facility (e.g., facility 16a) to pass through (step S2).

When the semiconductor product 18 arrives at the first work facility 16a, a worker manning the facility loads the work slip 20 sent along with the product 18 into the reader/writer 141 of the work terminal 14a to read information from the print indication area 201 of the slip 20. The information thus read is sent via the interface 142 to the host computer 101 of the central managing apparatus 10 (step S3).

The host computer 101 accesses the storage device 102 and searches it for any updates of task details corresponding to the received information identifying the semiconductor product 18 and instructing the task details associated therewith. The retrieved update information is returned to the interface 142 of the work terminal 14a connected to the work facility 16a (step S4).

The interface 142 of the work terminal 14a displays the returned task update information on the CRT display 144, and causes the reader/writer 141 concurrently to print the information on the variable print part 201b in the print indication area 201 of the loaded work slip 20 (step S5).

The worker verifies what is displayed on the CRT display 144 and, always carrying the work slip 20, performs necessary task in accordance with the latest task instructing information printed on the work slip 20 (step S6).

Upon completion of the task details as per the task instructions, the worker attaches the work slip 20 to the semiconductor product 18 on which task has been done, and forwards the product 18 together with the work slip 20 illustratively to the next work facility 14b (step S7).

Technical steps making up the inventive task instructing method in FIG. 3 are distributed easily for widespread use when recorded on diverse kinds of storage media 40 such as floppy discs, compact discs and magnetic tapes. As described, the work slip 20 serving as the task instruction sheet comprising the rewritable print indication area 201 has update information printed thereon much more quickly by the inventive reader/writer than by conventional printers. This makes it possible to print the most recent updates of task details as needed, thus readily reflecting any changes in process flows and task details in the actual task instructions.

Furthermore, the inventive method facilitates management of task modifications necessitated by updates in process flows and task details, allowing workers to respond promptly to the modifications. The time required to address any such updates is significantly shortened.

Because the task instruction sheet printed on paper is abolished and replaced by a card type storage medium comprising a rewritable print indication area, less paper is needed than before. When workers input a type name and a lot number of a given product to reference update information about task details of the product, the possibility of input error is minimized. This prevents the product from getting subjected to a wrong process based on inaccurate information.

The work slip 20 carried by workers bears the same information as that displayed on the CRT display 144. When workers leave the work terminals 14 to perform their task, they can verify task details wherever necessary by simply referring to the work slip 20 they always carry around. In the past, the need to go back to the work terminal 14 for verification of task details often tempted workers to skip the chore. The resulting inadequacy of task detail verification sometimes led to faulty task. The inventive method eliminates such irregularities and helps improve the yield rate. In addition, the enhanced work efficiency provided by the invention shortens the period of product fabrication.

The work slip 20 is a simple card having a rewritable print indication area 201. As such, the work slip 20 can be handled in a fairly carefree manner as long as the print indication area 201 is not deliberately scratched or otherwise manhandled. Being anything but a precision instrument, the work slip 20 does not malfunction even if inadvertently dropped on the ground. Workers can handle the work slip 20 easily and confidently at the work site and when attaching it to the semiconductor product 18 for transfer to the next process.

Although the foregoing description has focused on the semiconductor product as the typical workpiece, this is not limitative of the invention. The invention applies to other products that are transferred through a large number of processes at numerous work facilities when manufactured.

Constituted as described above, the inventive task instructing method and apparatus, storage medium for storing the method, card type storage medium used by the apparatus, and task instructing and managing apparatus offer the following major benefits:

According to one aspect of the invention, there is provided a task instructing method for use with a first and a second terminal device. The first terminal device comprises an interface for exchanging information with a central managing apparatus, which includes a storage unit storing update information about specific work facilities for processing a workpiece and about details of task to be carried out on the workpiece at each of the work facilities, a reader/writer for writing and reading information to and from a card type storage medium, which provides a print indication area to print information in a rewritable manner through the reader/writer, an input unit for entering information to the reader/writer, and a display unit for displaying information entered through the input unit. The second terminal device comprises an interface for exchanging information with the central managing apparatus, and a reader/writer for writing and reading information to and from the card type storage medium. The task instructing method includes the steps of: causing the first terminal device to print, on a card type storage medium that provides a print indication area to print information in a rewritable manner through the reader/writer, specific information identifying each workpiece and designating details of task to be carried out on the workpiece at the next work facility to be transferred in accordance with the update information retrieved from the storage unit, thus issuing the card type storage medium which is transferred together with the workpiece; and causing the second terminal device, by using the card type storage medium transferred together with the workpiece to the work facility in question, to access and search the central managing apparatus for update information about details of task to be carried out on the workpiece at the work facility in question, and to print details of task on the card type storage medium in accordance with the update information retrieved from the storage unit. This method facilitates delivery of task instructions that reflect changes in process flows and task details, allowing workers to respond promptly to updates of task details on the workpiece and of the processes involved.

In connection with the above task instructing method, the workpiece may be a semiconductor product. In this case, the method facilitates delivery of task instructions that reflect changes in process flows and task details during semiconductor fabrication, allowing workers to respond promptly to updates of task details on the semiconductor product and of the processes involved.

The card type storage medium may be a rewritable card constituted by a color-developing heat-sensitive rewritable material. The medium carries clearly printed indications that minimize inadequate communication of task details, whereby the yield rate of the workpiece is improved.

According to another aspect of the invention, there is provided a task instructing apparatus comprising: a central managing apparatus having a storage unit storing update information about specific work facilities for processing a workpiece and about details of task to be carried out on the workpiece at each of the work facilities; a first terminal device having an interface for exchanging information with the central managing apparatus, a reader/writer for writing and reading information to and from a card type storage medium, which provides a print indication area to print information in a rewritable manner through the reader/writer, an input unit for entering information to the reader/writer, and a display unit for displaying information entered through the input unit; and a second terminal device having an interface for exchanging information with the central managing apparatus, and a reader/writer for writing and reading information to and from the card type storage medium, the second terminal device being attached to each work facility. The most recent information is retrieved and printed on the card type storage medium. The inventive structure thus allows workers to respond promptly to changes in task details and process flows regarding the workpiece in question.

For the above task instructing apparatus, the workpiece may be a semiconductor product. Addressing the semiconductor product as the workpiece, this structure reads necessary information from the card type storage medium having the rewritable print indication area and, based on the information thus read, searches the central managing apparatus for the most recent task detail information about the semiconductor product to which the medium has been attached. The most recent information is retrieved and printed on the card type storage medium. The inventive structure thus allows workers to respond promptly to changes in task details and process flows regarding the semiconductor product.

According to a further aspect of the invention, there is provided a card type storage medium which is transferred together with a workpiece and which provides a print indication area to print information thereon in a rewritable manner, the information being such as identifying each workpiece and designating details of task to be carried out on the workpiece at the next work facility. The inventive card type storage medium permits inexpensive printing of a large quantity of task detail information about the workpiece at each work facility, and provides printed indications of any updates of the current task details in a simplified manner.

In connection with the above card type storage medium, the workpiece may be a semiconductor product. In this case, the inventive card type storage medium permits inexpensive printing of a large quantity of task detail information about the semiconductor product at each work facility, and provides printed indications of any updates of the current task details regarding the product in a simplified manner.

The above card type storage medium may be a rewritable card constituted by a color-developing heat-sensitive rewritable material. The medium carries clearly printed indications that minimize inadequate communication of task details.

According to an even further aspect of the invention, there is provided a task instructing and managing system comprising: a card type storage medium which is transferred together with a workpiece and which provides a print indication area to print information thereon in a rewritable manner, the information being such as dentifying each workpiece and designating details of task to be carried out on the workpiece at the next work facility; a central managing apparatus having a storage unit storing update information about specific work facilities for processing a workpiece and about details of task to be carried out on the workpiece at each of the work facilities; a first terminal device having an interface for exchanging information with the central managing apparatus, a reader/writer for writing and reading information to and from a card type storage medium, which provides a print indication area to print information in a rewritable manner through the reader/writer, an input unit for entering information to the reader/writer, and a display unit for displaying information entered through the input unit; and a second terminal device having an interface for exchanging information with the central managing apparatus, and a reader/writer for writing and reading information to and from the card type storage medium, the second terminal device being attached to each work facility. This structure reads necessary information from the card type storage medium transferred from one work facility to another along with the workpiece and, based on the information thus read, searches the central managing apparatus for the most recent task detail information about the workpiece to which the medium has been attached. The most recent information is retrieved and printed on the card type storage medium. Workers manning each facility are able to proceed with their task in accordance with the most recent task detail information printed on the card type storage medium. The inventive task instructing and managing system facilitates management of updates in task details and process flows regarding the workpiece and thus allows workers to respond promptly to such changes and modifications.

In connection with the above task instructing and managing system, the workpiece may be a semiconductor product. Addressing the semiconductor product as the workpiece, this structure reads necessary information from the card type storage medium transferred from one work facility to another along with the product and, based on the information thus read, searches the central managing apparatus for the most recent task detail information about the semiconductor product to which the medium has been attached. The most recent information is retrieved and printed on the card type storage medium. Workers manning each facility are able to proceed with their task in accordance with the most recent task detail information printed on the card type storage medium. The inventive task instructing and managing system facilitates management of updates in task details and process flows regarding the semiconductor product and thus allows workers to respond promptly to such changes and modifications.

In conjunction with the above task instructing and managing system, the card type storage medium may be a rewritable card constituted by a color-developing heat-sensitive rewritable material. The medium carries clearly printed indications that minimize inadequate communication of task details. Using this card type storage medium, the inventive task instructing and managing system minimizes the possibility of erroneous instructions reaching the workers.

According to a still further aspect of the invention, there is provided a storage medium which stores a task instructing method for use with a first and a second terminal device. The first terminal device comprises an interface for exchanging information with a central managing apparatus, which includes a storage unit storing update information about specific work facilities for processing a workpiece and about details of task to be carried out on the workpiece at each of the work facilities, a reader/writer for writing and reading information to and from a card type storage medium, which provides a print indication area to print information in a rewritable manner through the reader/writer, an input unit for entering information to the reader/writer, and a display unit for displaying information entered through the input unit. The second terminal device comprises an interface for exchanging information with the central managing apparatus, and a reader/writer for writing and reading information to and from the card type storage medium. The task instructing method including the steps of: causing the first terminal device to print, on a card type storage medium that provides a print indication area to print information in a rewritable manner through the reader/writer, specific information identifying each workpiece and designating details of task to be carried out on the workpiece at the next work facility to be transferred in accordance with the update information retrieved from the storage unit, thus issuing the card type storage medium which is transferred together with the workpiece; and causing the second terminal device, by using the card type storage medium transferred together with the workpiece to the work facility in question, to access and search the central managing apparatus for update information about details of task to be carried out on the workpiece at the work facility in question, and to print details of task on the card type storage medium in accordance with the update information retrieved from the storage unit.

This storage medium of the invention readily permits widespread distribution of technical steps constituting the above task instructing method that facilitates delivery of task instructions reflecting changes in process flows and task details. Implementing the method thus distributed allows workers to respond promptly to updates of task details on the workpiece and of the processes involved.

In connection with the above storage medium, the workpiece may be a semiconductor product. In this case, the storage medium readily permits extensive distribution of the technical steps constituting the task instructing method allowing workers to respond promptly to changes in task details and process flows regarding the semiconductor product.

Furthermore, the card type storage medium may be a rewritable card constituted by a color-developing heat-sensitive rewritable material in connection with the above storage medium. In this case, too, the storage medium readily provides widespread distribution of the technical steps constituting the task instructing method taking advantage of the card type storage medium that carries clearly printed indications minimizing inadequate communication of task details.

While the presently preferred embodiments of the present invention have been shown and described, it is to be understood these disclosures are for the purpose of illustration and that various changes and modifications may be made without departing from the scope of the invention as set forth in the appended claims.

The entire disclosure of a Japanese Patent Application No. 2000-190127, filed on Jun. 23, 2000 including specification, claims, drawings and summary, on which the Convention priority of the present application is based, are incorporated herein by reference in its entirety.

What is claimed is:

1. A task instructing method for use with a task instructing apparatus, said task instructing apparatus including a first and a second terminal device;
the first terminal device comprising an interface for exchanging information with a central managing apparatus, which includes a storage unit storing update information about specific work facilities for processing a workpiece and about details of task to be carried out on the workpiece at each of the work facilities, a reader/writer for writing and reading information to and from a card type storage medium, which provides a print indication area to print information in a rewritable manner through the reader/writer, an input unit for entering information to the reader/writer, and a display unit for displaying information entered through the input unit; and
the second terminal device comprising an interface for exchanging information with the central managing apparatus, and a reader/writer for writing and reading information to and from the card type storage medium;
said task instructing method including the steps of:
causing the first terminal device to print, on a card type storage medium that provides a print indication area to print information in a rewritable manner through the reader/writer, specific information identifying each workpiece and designating details of task to be carried out on the workpiece at the next work facility to be transferred in accordance with the update information retrieved from the storage unit, thus issuing the card type storage medium which is transferred together with the workpiece; and
causing the second terminal device, by using the card type storage medium transferred together with the workpiece to the work facility in question, to access and search the central managing apparatus for update information about details of task to be carried out on the workpiece at the work facility in question, and to print details of task on the card type storage medium in accordance with the update information retrieved from the storage unit.

2. The task instructing method according to claim 1, wherein said workpiece is a semiconductor product.

3. The task instructing method according to claim 1, wherein said card type storage medium is a rewritable card constituted by a color-developing heat-sensitive rewritable material.

4. The task instructing method according to claim 2, wherein said card type storage medium is a rewritable card constituted by a color-developing heat-sensitive rewritable material.

5. A task instructing apparatus comprising:
a central managing apparatus having a storage unit storing update information about specific work facilities for processing a workpiece and about details of task to be carried out on the workpiece at each of the work facilities;
a first terminal device having an interface for exchanging information with said central managing apparatus, a reader/writer for writing and reading information to and from a card type storage medium, which provides a print indication area to print information in a rewritable manner through the reader/writer, an input unit for entering information to the reader/writer, and a display unit for displaying information entered through the input unit; and
a second terminal device having an interface for exchanging information with the central managing apparatus, and a reader/writer for writing and reading information to and from the card type storage medium, said second terminal device being attached to each work facility.

6. The task instructing apparatus according to claim 5, wherein said workpiece is a semiconductor product.

7. A card type storage medium which is transferred together with a workpiece and which provides a print indication area to print information thereon in a rewritable manner, said information being such as identifying each workpiece and designating details of task to be carried out on the workpiece at the next work facility.

8. The card type storage medium according to claim 7, wherein said workpiece is a semiconductor product.

9. The card type storage medium according to claim 7, wherein said card type storage medium is a rewritable card constituted by a color-developing heat-sensitive rewritable material.

10. The card type storage medium according to claim 8, wherein said card type storage medium is a rewritable card constituted by a color-developing heat-sensitive rewritable material.

11. A task instructing and managing system comprising:
a card type storage medium which is transferred together with a workpiece and which provides a print indication area to print information thereon in a rewritable manner, said information being such as identifying each workpiece and designating details of task to be carried out on the workpiece at the next work facility;
a central managing apparatus having a storage unit storing update information about specific work facilities for processing a workpiece and about details of task to be carried out on the workpiece at each of the work facilities;
a first terminal device having an interface for exchanging information with said central managing apparatus, a reader/writer for writing and reading information to and from a card type storage medium, which provides a print indication area to print information in a rewritable manner through the reader/writer, an input unit for entering information to the reader/writer, and a display unit for displaying information entered through the input unit; and
a second terminal device having an interface for exchanging information with the central managing apparatus, and a reader/writer for writing and reading information to and from the card type storage medium, said second terminal device being attached to each work facility.

12. The task instructing and managing system according to claim 11, wherein said workpiece is a semiconductor product.

13. The task instructing and managing system according to claim 11, wherein said card type storage medium is a rewritable card constituted by a color-developing heat-sensitive rewritable material.

14. The task instructing and managing system according to claim 12, wherein said card type storage medium is a rewritable card constituted by a color-developing heat-sensitive rewritable material.

15. A storage medium which stores a task instructing method, said task instructing method being used with a first and a second terminal device; the first terminal device comprising an interface for exchanging information with a central managing apparatus, which includes a storage unit storing update information about specific work facilities for processing a workpiece and about details of task to be carried out on the workpiece at each of the work facilities, a reader/writer for writing and reading information to and from a card type storage medium, which provides a print indication area to print information in a rewritable manner through the reader/writer, an input unit for entering information to the reader/writer, and a display unit for displaying information entered through the input unit, and the second terminal device comprising an interface for exchanging information with the central managing apparatus, and a reader/writer for writing and reading information to and from the card type storage medium;
said task instructing method including the steps of:
causing the first terminal device to print, on a card type storage medium that provides a print indication area to print information in a rewritable manner through the reader/writer, specific information identifying each workpiece and designating details of task to be carried out on the workpiece at the next work facility to be transferred in accordance with the update information retrieved from the storage unit, thus issuing the card type storage medium which is transferred together with the workpiece; and
causing the second terminal device, by using the card type storage medium transferred together with the workpiece to the work facility in question, to access and search the central managing apparatus for update information about details of task to be carried out on the workpiece at the work facility in question, and to print details of task on the card type storage medium in accordance with the update information retrieved from the storage unit.

16. The storage medium according to claim 15, wherein said workpiece is a semiconductor product.

17. The storage medium according to claim 15, wherein said card type storage medium is a rewritable card constituted by a color-developing heat-sensitive rewritable material.

18. The storage medium according to claim 16, wherein said card type storage medium is a rewritable card constituted by a color-developing heat-sensitive rewritable material.
